(19) United States
(12) Patent Application Publication
(10) Pub. No.: US 2020/0324871 A1
(43) Pub. Date: Oct. 15, 2020

(54) AIRCRAFT WING

(71) Applicant: Airbus Operations Ltd., Bristol (GB)

(72) Inventors: Henry EDWARDS, Bristol (GB); Miguel PENA-HERRERO, Bristol (GB)

(21) Appl. No.: 16/843,399

(22) Filed: Apr. 8, 2020

(30) Foreign Application Priority Data
Apr. 9, 2019 (GB) 1904984.0

(51) Int. Cl. B64C 3/00; B64C 3/16; B64C 3/34; B64C 25/14; B64D 27/02; B64C 7/00; B64C 3/40; B64D 33/02

(52) U.S. Cl. CPC B64C 3/00; B64C 3/16; B64C 3/34; B64D 33/02; B64D 27/02; B64C 7/00; B64C 3/40; B64C 25/14

(57) ABSTRACT

An aircraft wing with a root, a tip, an inboard wing part, an outboard wing part, and a junction between the inboard wing part and the outboard wing part. The inboard wing part has anhedral and is swept back so that it extends downwardly and aft away from the root towards the junction. The outboard wing part has dihedral and is swept forward so that it extends upwardly and forward away from the junction towards the tip. An engine and landing gear are mounted at the junction. An aircraft with a pair of such wings has a W-shaped profile viewed from above, and an inverted gull-wing profile viewed from the front.

### CROSS-REFERENCE TO RELATED APPLICATION

This application claims priority to GB 1904984.0 filed Apr. 9, 2019, the entire disclosure of which is incorporated by reference herein.

### TECHNICAL FIELD

The disclosure herein relates to an aircraft wing, and an aircraft.

### BACKGROUND

US2018/105255 discloses an aircraft which defines a lifting volume including at least part of the central body housing the transported payload. The volume has a conventional aerodynamic profile along the longitudinal direction of the aircraft, with portions of wings projecting symmetrically and transversely at both sides thereof. From the longitudinal axis the wings at each side shows corresponding first sections which has anhedral and forward sweep until reaching corresponding inflexion points from which two distal second sections or tracts project with positive dihedral and backward sweep until reaching the wingtips of the projected wingspan.

### SUMMARY

According to an aspect of the disclosure herein, there is provided an aircraft wing comprising a root; a tip; an inboard wing part; an outboard wing part; and a junction between the inboard wing part and the outboard wing part, wherein the inboard wing part has anhedral and is swept back so that it extends downwardly and aft away from the root towards the junction, and the outboard wing part has dihedral and is swept forward so that it extends upwardly and forward away from the junction towards the tip.

The span-wise position of the junction can be tailored, along with the anhedral, dihedral and sweep angles of the inboard and outboard wing parts, to control the aerodynamic properties of the wing.

Optionally the wing further comprises an engine, which preferably is mounted at the junction. Positioning the engine at the junction enables fuel to flow “downhill” towards the engine through the inboard wing part and/or the outboard wing part. Alternatively the engine may be mounted to the inboard part, offset from the junction in a span-wise sense.

Optionally at least part of the engine is positioned below the junction viewed from a front of the aircraft wing, but most preferably at least part of the engine is positioned above the junction viewed from a front of the aircraft wing.

A second aspect of the disclosure herein provides an aircraft wing comprising a root; a tip; an inboard wing part; an outboard wing part; and a junction between the inboard wing part and the outboard wing part, wherein the inboard wing part has anhedral so that it extends downwardly away from the root towards the junction, the outboard wing part has dihedral so that it extends upwardly away from the junction towards the tip, and the wing further comprising an engine, wherein at least part of the engine is positioned above the junction viewed from a front of the aircraft wing.

Positioning the engine above the wing in the anhedral/dihedral “valley” provides a compact arrangement (compared with an engine mounted under the wing) which is suited to landing in high cross-winds.

A further aspect of the disclosure herein provides an aircraft comprising a pair of wings according to the first or second aspect of the disclosure herein. Optionally the aircraft may comprise a flying wing with no fuselage. In this case the roots of each wing of the pair of wings meet at the center line of the aircraft. Alternatively the aircraft comprises: a fuselage; and a pair of wings according to the first or second aspect of the disclosure herein carried by the fuselage.

A further aspect of the disclosure herein provides an aircraft comprising: a fuselage; and a pair of wings carried by the fuselage, each wing comprising; an inboard wing part; an outboard wing part; a tip; a junction between the inboard wing part and the outboard wing part; an engine mounted at the junction; and a landing gear mounted at the junction, wherein the inboard wing part has anhedral so that it extends downwardly away from the fuselage and towards the junction, and the outboard wing part has dihedral so that it extends upwardly away from the junction and towards the tip.

Mounting both the landing gear and the engine at the junction enables the same wing structure to be used to support them both and provides a more balanced wing arrangement.

The following comments apply to all aspects of the disclosure herein.

Optionally the wing comprises a fuel tank, and the engine is arranged to receive fuel from the fuel tank. The fuel tank may be in the inboard wing part, the outboard wing part, or in a wing pod at the junction or another part of the wing.

Alternatively the wing may have no fuel tank, or the engine may be arranged to receive fuel from a fuel tank in a fuselage of an aircraft to which the wing is attached.

Typically the engine is configured to generate thrust along a line of thrust which is positioned above the junction. This makes the thrust closer to the vertical mid-plane of the aircraft, which adds to the efficiency of the configuration compared with an engine mounted under the wing.

Most preferably the engine has an air intake at least partially positioned above the junction viewed from a front of the aircraft wing.

Optionally the junction has a nose, and the engine has an air intake positioned aft of the nose of the junction viewed from above the aircraft wing.

Optionally the inboard wing part and the outboard wing part each comprises a leading edge, a trailing edge and a mid-chord line, and the engine has an air intake positioned aft of both mid-chord lines viewed from above the aircraft wing.

Optionally the engine has an air intake positioned to ingest boundary layer air which has flowed across the junction.

Optionally the engine has an air intake positioned to ingest a first span-wise flow of air which has flowed outwardly along an upper surface of the inboard wing part towards the junction and a second span-wise flow of air which has flowed inwardly along an upper surface of the outboard wing part towards the junction.

Optionally the fuel tank meets the junction at a low point of the fuel tank.

Optionally the engine is a podded jet engine.

Optionally the junction comprises a wing break where the inboard part meets the outboard part. The junction may comprise an abrupt wing break with no pod or other aerodynamic fairing, or the junction may comprise a pod which optionally may carry landing gear and/or an engine.

Optionally the junction comprises a pod, and the engine comprises an air intake at least partially positioned above the pod viewed from a front of the aircraft wing.

Optionally the wing further comprises a landing gear mounted at the junction. The landing gear may be fixed, but more preferably it is retractable. Optionally the landing gear is retractable into a pod at the junction.

Optionally the landing gear is retractable, and the junction comprises a pod with one or more landing gear bay doors which can be opened to enable the landing gear to be retracted into the pod.

Optionally the landing gear is retractable in a forward or aft direction.

Most preferably the landing gear is retractable in a forward direction, which may be away from the engine.

Optionally a lowest point of the wing is at the junction.

Optionally the inboard wing part and the outboard wing part each have an aerofoil cross-section arranged to generate lift.

Optionally the inboard wing part and the outboard wing part each comprises a leading edge, a trailing edge, and upper and lower surfaces running from the leading edge to the trailing edge.

The leading edge and/or the trailing edge of the inboard wing part may be swept back. Preferably a mid-chord line or a quarter-chord line of the inboard wing part is swept back.

The leading edge and/or the trailing edge of the outboard wing part may be swept forward. Preferably a mid-chord line or a quarter chord line of the outboard wing part is swept forward.

The lower surface and/or the upper surface of the inboard wing part may extend downwardly away from the root towards the junction.

The lower surface and/or the upper surface of the outboard wing part may extend upwardly away from the junction towards the tip.

The aircraft wing has a span from its root to its tip, and optionally the inboard wing part and/or the outboard wing part has a span which is greater than 10% of the span of the wing.

The aircraft wing has a span from its root to its tip, and optionally the outboard wing part has a span which is greater than 20% of the span of the wing or greater than 50% of the span of the wing.

Optionally the outboard wing part extends upwardly away from the junction towards the tip at a dihedral angle which on average is less than 30° or less than 20°.

Optionally the inboard wing part extends downwardly away from the root towards the junction at an anhedral angle which on average is less than 45° or less than 30°.

Optionally the inboard wing part extends to the root of the wing. Alternatively there may be further wing parts between the inboard wing part and the root of the wing.

Preferably the inboard wing part has anhedral and/or is swept back along its full span all the way to the root of the wing.

Optionally the outboard wing part extends to the tip of the wing, which may carry a wing tip device such as a winglet. Alternatively there may be further wing parts between the outboard wing part and the tip.

Preferably the outboard wing part has dihedral and/or is swept forward along its full span all the way to the tip of the wing.

Optionally the pair of wings have a W-shaped planform profile.

Optionally the (or each) wing has an inverted gull-wing profile.

### BRIEF DESCRIPTION OF THE DRAWINGS

Embodiments of the disclosure herein will now be described with reference to the accompanying drawings, in which:

FIG. 1 is a front view of an aircraft;

FIG. 2 is a port view of the aircraft of FIG. 1;

FIG. 3 is a plan view of the aircraft of FIG. 1;

FIG. 4 is a front view of part of the port wing;

FIG. 5 shows part of the port wing showing air flow into the engine;

FIG. 6 shows part of the port wing with an alternative engine mounting arrangement;

FIG. 7 is a port view of the aircraft showing the landing gear in extended and retracted positions; and

FIG. 8 is a port view of the aircraft showing landing gear 35% bigger than in FIG. 7.

### DETAILED DESCRIPTION

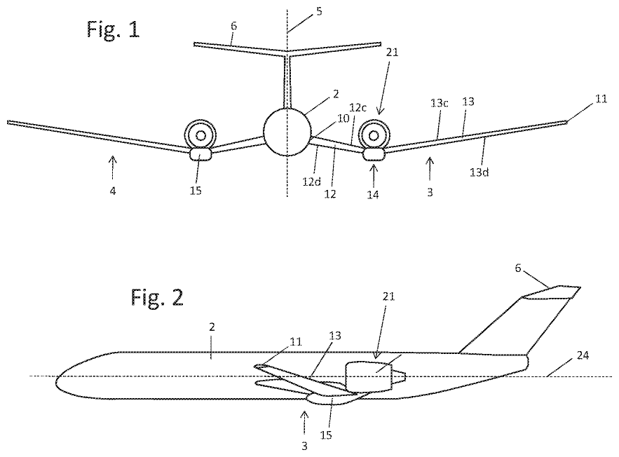

An aircraft shown in FIGS. 1-3 comprises a fuselage 2; and a pair of wings 3, 4 carried by the fuselage. The aircraft is symmetrical about a plane of symmetry 5, so only the port wing 3 is labelled in detail.

Each wing comprises a root 10 attached to the fuselage 2; a tip 11; an inboard wing part 12; an outboard wing part 13; and a junction 14 between the inboard wing part and the outboard wing part. The junction has a pod 15.

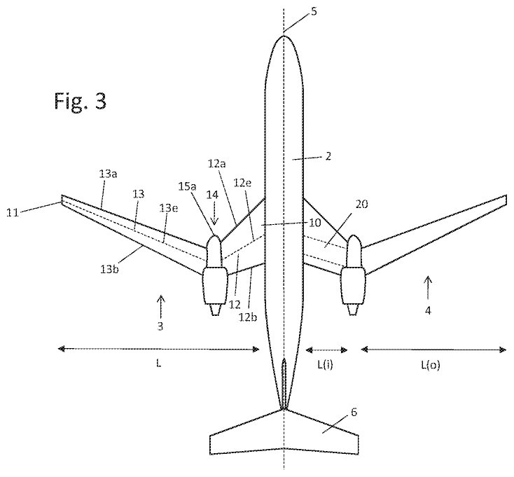

The pair of wings have a W-shaped planform profile view from above as in FIG. 3, and an inverted gull-wing profile viewed from the front as in FIG. 1.

Each wing part comprises a leading edge 12a, 13a; a trailing edge 12b, 13b; an upper surface 12c, 13c running from the leading edge to the trailing edge; and a lower surface 12d, 13d also running from the leading edge to the trailing edge. Mid-chord lines 12e, 13e shown in FIG. 3 are positioned half way between the leading and trailing edges. The inboard wing part and the outboard wing part each have an aerofoil cross-section arranged to generate lift.

The inboard wing part 12 has anhedral and is swept back so that it extends downwardly and aft away from the root 10 and the fuselage 2 towards the junction 14. The leading edge 12a, trailing edge 12b and mid-chord line 12e of the inboard wing part 12 are all swept back as shown in FIG. 3, all the way from the root 10 to the junction 14. The upper surface 12c and lower surface 12d of the inboard part are both anhedral as shown in FIG. 1, also all the way from the root 10 to the junction 14.

The outboard wing part 13 has dihedral and is swept forward so that it extends upwardly and forward away from the junction 14 towards the tip 11. The leading edge 13a, trailing edge 13b and mid-chord line 13e of the outboard wing part 13 are all swept forward as shown in FIG. 3, all the way from the junction 14 to the tip 11. The upper surface 13c and lower surface 13d of the outboard wing part are both dihedral as shown in FIG. 1, also all the way from the junction 14 to the tip 11.

As shown in FIG. 3, the aft sweep angle of the mid-chord line 12e of the inboard wing part 12 is of the order of 40°-50°, and greater than the forward sweep angle of the mid-chord line 13e of the outboard wing part which is of the order of 20°-30°.

The forward sweep of the outboard wing part 13 moves the mean aerodynamic chord and center of gravity forward which helps with handling qualities, load-ability and potentially offers a way to reduce trim drag.

The forward sweep of the outboard wing part 13 can also help to reduce the yaw stability of the aircraft and potentially reduce the control effort needed to maneuver.

The anhedral angle of the inboard wing part 12 may be in the range of 2°-45°, and is greater than the dihedral angle of the outboard wing part 14 which may be in the range of 2°-12°.

The interior of the inboard wing part 12 comprises a fuel tank 20 shown in dashed lines in FIG. 3. A podded jet engine 21 is mounted at the junction 14 and arranged to receive fuel from the fuel tank 20. The outboard wing part 13 is preferably dry (that is, with no fuel tank) but alternatively it may also house a fuel tank which feeds the engine 21. A center fuel tank in the fuselage may also feed fuel to the engines.

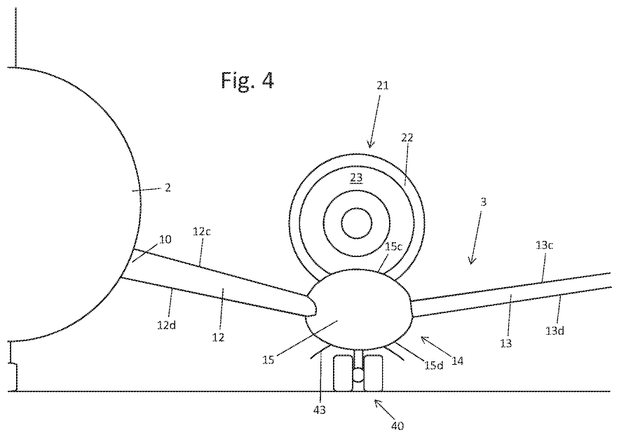

As shown in FIG. 4, the engine 21 comprises a nacelle 22 with an air intake 23. The engine 21 is positioned above the junction 14 viewed from the front of the aircraft wing as in FIG. 4, with its air intake 23 positioned aft of the nose 15a of the pod and aft of the mid-chord lines 12e, 13e viewed from above the aircraft wing as in FIG. 3.

The engine is configured to generate thrust along a line of thrust 24 which is positioned above the junction as shown in FIGS. 2 and 4.

The engine 21 is a turbofan engine, but in alternative embodiments the engine 21 may drive a propeller, or a counter rotating open rotor. Alternatively the aircraft may have an engine in the fuselage which drives a propeller mounted at the junction 14.

The fuel tank 20 meets the junction 14 at a low point of the fuel tank. This enables fuel to be fed “downhill” by gravity to the low point, then pumped the small distance to the engine. This minimizes the amount of pipework required in the fuel tank, and the size or number of pumps, thus improving operational reliability and reducing moving parts.

The outboard wing part 13 may be “dry” (that is, not containing fuel) or it may also include an outboard fuel tank which feeds the engine or the inboard fuel tank, again using gravity to feed fuel to the engine.

The junction 14 provides a wing break where the inboard part meets the outboard part, and the pod 15 at the junction is positioned below the air intake 23 of the engine viewed from a front of the aircraft wing as in FIG. 4.

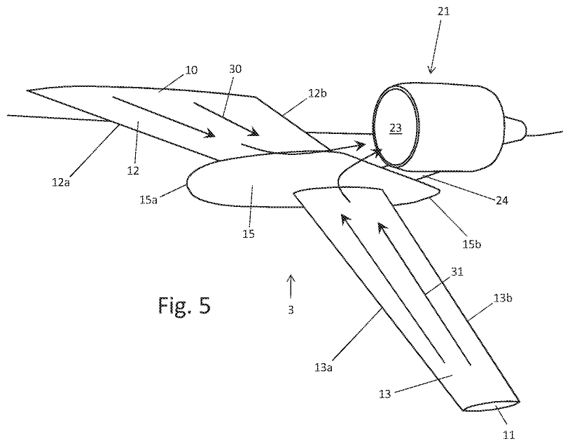

The pod 15 has a nose 15a and a tail 15b shown most clearly in FIG. 5. The upper surface of the pod 15 may be flat as shown in FIG. 1, it may conform with the shape of the wing, it may be convex viewed from the front as indicated at 15c in FIG. 4, or it may be formed with a concave scalloped recess (not shown). The lower surface of the pod 15 may be flat as shown in FIG. 1, or convex viewed from the front as indicated at 15d in FIG. 4.

As can be seen in FIGS. 4 and 5, the bottom of the air intake 23 is positioned just above the upper surface 15c of the pod to ingest boundary layer air which has flowed across the upper surface 15c.

The W-wing planform shown in FIG. 3 causes a span-wise outflow 30 of air shown in FIG. 5 to flow outwardly along the upper surface of the inboard wing part towards the junction 14, and a span-wise inflow 31 of air to flow inwardly along the upper surface of the outboard wing part towards the junction. The air intake 23 is positioned where the sweep is locally zero and the outflow 30 meets the inflow 31, so it ingests both of these flows of air, enhancing the ram-air effect for the engine.

Positioning the engine in the anhedral/dihedral “valley” as shown in FIG. 4 may further enhance the ram-air effect, compared with a gull wing (dihedral/anhedral) or flat wing shape. Positioning the engine towards the bottom of the anhedral/dihedral “valley” as shown in FIG. 4 also provides a compact arrangement (compared with an engine mounted under the wing) which is suited to landing in high cross-winds which tend to create roll and yaw of the aircraft which could cause an under-wing engine to clash with the ground.

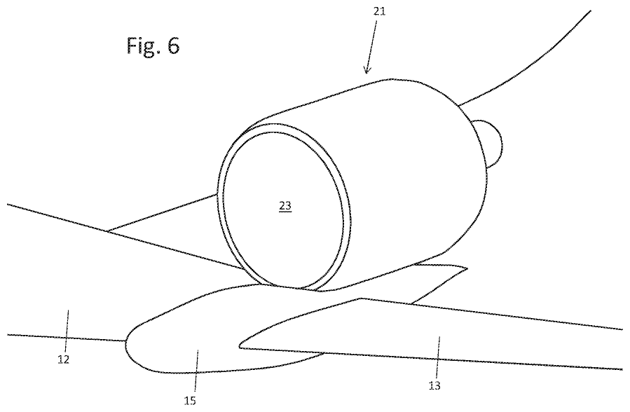

The engine 21 is mounted above and aft of the wing on a pylon 24 shown in FIG. 5 which extends up and aft from the tail 15b of the pod. This enables the engine 21 to be positioned in clean air flow. In an alternative arrangement shown in FIG. 6 the engine 21 may be embedded in the upper surface of the pod rather than mounted on a pylon.

The over-wing positioning of the engine air intake 23 helps with shielding observers on the ground from fan-noise, and thus could help to reduce the perceived aircraft noise level during take-off. The position of the engine 21 aft of the wing could also help to shield the air intake and fan from bird strike at high angles of attack.

The position of the engine aft of the wing also moves some of the particular risks associated with uncontained engine failure away from the wing. The opposite engine could be protected by some local armour/protection in the fuselage area. This would permit some simplification of systems and reduce penalising system segregation rules on the wing.

As shown in FIG. 2, positioning the engine 21 over the wing makes its line of thrust 24 closer to the vertical mid-plane of the aircraft, which adds to the efficiency of the configuration.

The aircraft has a high T-tail with a horizontal tail 6 up and out of the engine wake. The high tail 6 may also help to keep the pitch control of the aircraft, by providing a delay to deep-stall problems for the aircraft at very high angles of attack.

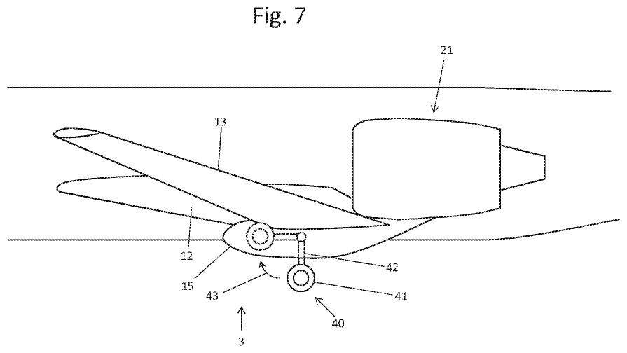

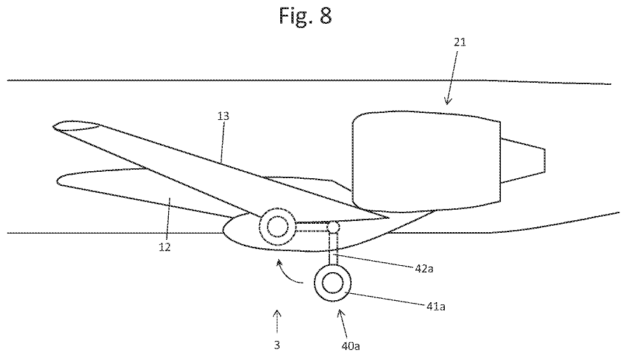

The pod 15 carries not only the engine 20 but also landing gear 40 shown in FIGS. 4 and 7. As shown in FIG. 7, the landing gear 40 is retractable in a forward direction, away from the engine 21. The landing gear comprise a pair of wheels 41 mounted on a strut 42 which can be rotated up and forward as indicated by arrow 43 to stow the landing gear in the pod 15. Retracting the landing gear up and forward is advantageous, since in a failure scenario air flow will tend to push the landing gear down into its extended position.

As shown in FIG. 4, a lowest point of the wing is at the junction 14, so the length of the landing gear 40 is minimised. This makes the landing gear sufficiently small to fit into the pod 15, as well as reducing the weight, drag and noise of the landing gear in flight.

FIG. 8 is a port view of the aircraft showing alternative landing gear 40a, 41a, 42a which is bigger than in FIG. 7. The pivot point is positioned further aft so the landing gear can fit within the pod.

The “aft and out” position of the landing gear 40 relative to the fuselage helps with the handling qualities and load-ability of the aircraft. The span-wise position of the landing gear also removes the need for a belly fairing between the wing and the fuselage, where landing gear is conventionally stowed. This could reduce final assembly time, since the region of the wing-fuselage junction is complex to assemble.

Mounting both the landing gear and the engine at the junction 14 provides a synergistic effect since it enables the same structure (such as the pod 15 and/or strengthened internal structures) to be used to support them, and provides a balanced wing arrangement.

The pod 15 may have landing gear bay doors 43 shown in FIG. 4 which can be opened to enable the landing gear to be retracted into the pod. Alternatively the pod may be permanently open with no landing bay doors as shown in FIG. 7. Alternatively, the landing gear may be retracted into a landing gear bay in the inboard wing part 12 between the fuel tank 20 and the leading edge 12a.

Each aircraft wing has a span (indicated by letter L in FIG. 3) from its root to its tip (the span being measured perpendicular to the plane of symmetry 5 of the aircraft). The inboard wing part 12 has a span L(i) which is about 10%-30% of the span L of the wing. The outboard wing part 12 has a span L(o) which is about 70%-90% of the span L of the wing.

The span-wise position of the junction 14 can be tailored to control the aerodynamic properties of the wing, and in order to obtain sufficient wing bending relief from the combined weight of the engine and landing gear.

The span-wise position of the junction 14 can also be tailored to control the positions of the landing gear and hence the track width of the aircraft.

Optionally flap and spoiler supports could be integrated into the pod area, making use of the local reinforcement needed for the engine and landing gear to provide integration opportunities, at low or neutral weight impact versus traditional discrete structural support architecture (flap beams, for example).

Where the word ‘or’ appears this is to be construed to mean ‘and/or’ such that items referred to are not necessarily mutually exclusive and may be used in any appropriate combination.

Although the disclosure herein has been described above with reference to one or more preferred embodiments, it will be appreciated that various changes or modifications may be made without departing from the scope of the disclosure herein as defined in the appended claims.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft wing comprising a root; a tip; an inboard wing part; an outboard wing part; and a junction between the inboard wing part and the outboard wing part, wherein the inboard wing part has anhedral and is swept back so that it extends downwardly and aft away from the root towards the junction, and the outboard wing part has dihedral and is swept forward so that it extends upwardly and forward away from the junction towards the tip, and further comprising an engine, wherein the inboard wing part and the outboard wing part each comprise a leading edge, a trailing edge and a mid-chord line, and the engine has an air intake positioned aft of both mid-chord lines viewed from above the aircraft wing.

2. The aircraft wing according to claim 1, wherein the engine is mounted at the junction.

3. The aircraft wing according to claim 1, wherein at least part of the engine is positioned above the junction viewed from a front of the aircraft wing.

4. The aircraft wing according to claim 1, wherein the wing comprises a fuel tank, and the engine is arranged to receive fuel from the fuel tank.

5. The aircraft wing according to claim 1, wherein the air intake is positioned to ingest a first span-wise flow of air which has flowed outwardly along an upper surface of the inboard wing part towards the junction and a second span-wise flow of air which has flowed inwardly along an upper surface of the outboard wing part towards the junction.

6. The aircraft wing according to claim 1, wherein the junction comprises a pod, and at least part of the engine is positioned above the pod viewed from a front of the aircraft wing.

7. The aircraft wing according to claim 1, wherein the air intake is positioned to ingest boundary layer air which has flowed across the junction.

8. The aircraft wing according to claim 1, wherein the junction comprises a pod.

9. The aircraft wing according to claim 1, further comprising a landing gear mounted at the junction.

10. The aircraft wing according to claim 9, wherein the junction comprises a pod and the landing gear is retractable into the pod.

11. The aircraft wing according to claim 9, wherein the landing gear is retractable in a forward direction.

12. The aircraft wing according to claim 1, wherein the aircraft wing has a span from its root to its tip, and wherein the inboard wing part and/or the outboard wing part has a span which is greater than 10%, 20% or 50% of the span of the wing.

13. The aircraft wing according to claim 1, wherein the inboard wing part has a span which is less than a span of the outboard wing part.

14. An aircraft comprising a pair of wings according to claim 1.

15. An aircraft comprising: a fuselage; and a pair of wings carried by the fuselage, each wing comprising; an inboard wing part; an outboard wing part; a tip; a junction between the inboard wing part and the outboard wing part; an engine mounted at the junction; and a landing gear mounted at the junction, wherein the inboard wing part has anhedral so that it extends downwardly away from the fuselage and towards the junction, and the outboard wing part has dihedral so that it extends upwardly away from the junction and towards the tip, wherein each inboard wing part has anhedral and is swept back so that it extends downwardly and aft away from the root towards the junction, and each outboard wing part has dihedral and is swept forward so that it extends upwardly and forward away from the junction towards the tip.

16. An aircraft wing comprising a root; a tip; an inboard wing part; an outboard wing part; and a junction between the inboard wing part and the outboard wing part, wherein the inboard wing part has anhedral and is swept back so that it extends downwardly and aft away from the root towards the junction, and the outboard wing part has dihedral and is swept forward so that it extends upwardly and forward away from the junction towards the tip, further comprising an engine, wherein the engine has an air intake positioned to ingest a first span-wise flow of air which has flowed outwardly along an upper surface of the inboard wing part towards the junction and a second span-wise flow of air which has flowed inwardly along an upper surface of the outboard wing part towards the junction.
